(19) United States
(12) Patent Application Publication
(10) Pub. No.: US 2014/0094076 A1
(43) Pub. Date: Apr. 3, 2014

(54) Microporous Materials With Fibrillar Mesh Structure and Methods of Making and Using the Same

(71) Applicants: James S. Mrozinski, Oakdale, MN (US); Harold Todd Freemyer, Woodbury, MN (US); Kuan-Yin Lin, Woodbury, MN (US)

(72) Inventors: James S. Mrozinski, Oakdale, MN (US); Harold Todd Freemyer, Woodbury, MN (US); Kuan-Yin Lin, Woodbury, MN (US)

(21) Appl. No.: 14/111,777

(22) PCT Filed: Jun. 14, 2012
(86) PCT No.: PCT/US12/42406

§ 371 Date: Oct. 15, 2013

Related U.S. Application Data
(60) Provisional application No. 61/497,733, filed on Jun. 16, 2011.

(51) Int. Cl. B29C 55/00

(52) U.S. Cl. CPC B29C 55/005
USPC 442/56; 442/50; 264/49

(57) ABSTRACT

Microporous materials including a melt-processable, semi-crystalline, thermoplastic (co)polymer, wherein the thermoplastic (co)polymer is miscible in a compatible liquid when heated above a melting temperature of the semi-crystalline thermoplastic (co)polymer, further wherein the microporous material is comprised of a plurality of filaments substantially aligned in a first longitudinal direction, and a mesh extending laterally between the filaments, the mesh comprising a network of interconnected pores having a median diameter less than one micrometer. Methods of making and using such microporous materials (e.g. as films, membranes, battery separators, capacitor separators, fluid filtration articles, separation articles, and the like) are also described.

### CROSS REFERENCE TO RELATED APPLICATIONS

This application claims priority from U.S. Provisional Application Ser. No. 61/497,733, filed Jun. 16, 2011, the disclosure of which is incorporated by reference in its/their entirety herein.

### TECHNICAL FIELD

The present disclosure relates to microporous materials and methods of making and using such materials. The disclosure further relates to articles (e.g., sheets, tubes, hollow fibers, films, membranes, and the like) made from microporous materials, and methods of preparing and using such articles.

### BACKGROUND

Porous materials are materials that have porous structures which enable fluids to pass readily through them. Microporous materials generally have pores with an effective diameter typically at least several times the mean free path of the molecules passing through them, namely from several micrometers down to as low as about 100 Angstroms (0.01 micrometers). Membranes made from such microporous materials are usually opaque, even when made from an originally transparent material, because the membrane surfaces and internal pore structure scatter visible light.

Microporous membranes enjoy utility in a wide range of divergent applications, including use in fluid filtration to remove solid particulates, use in ultrafiltration to remove colloidal matter from fluids, use as diffusion barriers or separators in electrochemical cells, and uses in the preparation of synthetic leathers and fabric laminates. Microporous membranes also have been used in the filtration of antibiotics, beers, oils, bacteriological broths, and for the analysis of air, microbiological samples, intravenous fluids and vaccines. Surgical dressings, bandages and other fluid transmissive or absorptive medical articles likewise incorporate microporous membranes and films. Microporous membranes have also seen widespread use as battery separators (e.g. in lithium ion batteries).

### SUMMARY

Briefly, the present disclosure describes exemplary embodiments of a microporous material comprising a melt-processable semi-crystalline thermoplastic (co)polymer, and having a unique morphology consisting of fibrillar strands and a microporous mesh extending between the fibrillar strands. In some exemplary methods, these microporous materials can be produced at relatively high rates and low cost. In certain exemplary embodiments, the microporous materials are used to produce microporous films, membranes, and articles with advantageous features arising from incorporation of the microporous material.

Accordingly, in one aspect, the present disclosure describes a method of making a microporous material, including:
(a) melt blending to form a substantially homogeneous melt-blended mixture including from about 20 to about 70 parts by weight of a melt-processable, semi-crystalline, thermoplastic (co)polymer component, and from about 30 to about 80 parts by weight of a second component comprising a compound that is miscible with the thermoplastic (co)polymer component at a temperature above a melting temperature of the thermoplastic semi-crystalline (co)polymer but that phase separates from the thermoplastic (co)polymer component when cooled below a crystallization temperature of the thermoplastic semi-crystalline (co)polymer;
(b) forming a sheet of the melt blended mixture;
(c) cooling the sheet to a temperature at which phase separation occurs between the second component and the thermoplastic (co)polymer component through crystallization precipitation of the thermoplastic (co)polymer component;
(d) removing at least a substantial portion of the second component to provide a porous sheet; and
(e) stretching the porous sheet in a direction at a stretch ratio between 1:1 and 3:1, and stretching the sheet in a substantially orthogonal direction at a stretch ratio of more than 4:1, thereby forming a microporous material comprising a network of interconnected pores having a median diameter less than one micrometer.

Optionally, the microporous material exhibits a puncture resistance of at least 300 g/25 micrometers.

In some exemplary embodiments, the porous sheet, after step (e), exhibits a major surface areal expansion ratio of more than 4:1. In certain exemplary embodiments, the porous sheet is stretched in the substantially orthogonal direction before the porous sheet is stretched in the direction at the stretch ratio between 1:1 and 3:1. In other exemplary embodiments, the porous sheet is stretched in the substantially orthogonal direction after the porous sheet is stretched in the direction at the stretch ratio between 1:1 and 3:1. In alternative exemplary embodiments, the porous sheet is stretched in each direction at substantially the same time. In further exemplary embodiments, the porous sheet is stretched in the substantially orthogonal direction at a stretch ratio of no more than 12:1.

In further exemplary embodiments of any of the foregoing, the thermoplastic (co)polymer component comprises a semi-crystalline, thermoplastic (co)polymer selected from the group consisting of polypropylene, high density polyethylene, poly(ethylene chlorotrifluoroethylene), and compatible blends thereof.

In certain exemplary embodiments, the second component is selected from the group consisting of mineral oil, mineral spirits, paraffin wax, liquid paraffin, petroleum jelly, dioctylphthalate, dodecyl alcohol, hexadecyl alcohol, octadecyl alcohol, stearyl alcohol, dibutyl sebacate, and mixtures thereof which are miscible with the thermoplastic (co)polymer component at a temperature above the melting temperature of the thermoplastic semi-crystalline (co)polymer.

In additional exemplary embodiments, the second component further comprises one or more adjuvants selected from the group consisting of anti-static materials, surfactants, nucleating agents, dyes, plasticizers, UV absorbers, thermal stabilizers, flame retardants, nucleating agents, anti-oxidants, particulate fillers, and anti-oxidants.

In further exemplary embodiments of any of the foregoing, the sheet is stretched at a temperature between the alpha crystallization temperature and the melting temperature of the semi-crystalline, thermoplastic (co)polymer.

In another aspect, a microporous material is prepared according to any one of the foregoing aspect and embodiments.

In a further aspect, a microporous material is prepared including a melt-processable, semi-crystalline, thermoplastic (co)polymer, wherein the thermoplastic (co)polymer is miscible in a compatible liquid when heated above a melting temperature of the semi-crystalline thermoplastic (co)polymer, further wherein the microporous material is comprised of a plurality of filaments substantially aligned in a first longitudinal direction, and a mesh extending laterally between the filaments, the mesh comprising a network of interconnected pores having a median diameter less than one micrometer.

In some exemplary embodiments, the melt-processable, semi-crystalline thermoplastic (co)polymer is selected from the group consisting of polypropylene, high density polyethylene, poly(ethylene chlorotrifluoroethylene), and compatible blends thereof. In certain exemplary embodiments, the compatible liquid is selected from the group of consisting of mineral oil, mineral spirits, paraffin wax, liquid paraffin, petroleum jelly, dioctylphthalate, dodecyl alcohol, hexadecyl alcohol, octadecyl alcohol, stearyl alcohol, dibutyl sebacate, and mixtures thereof which are miscible with the thermoplastic (co)polymer at a temperature above the melting temperature of the thermoplastic semi-crystalline (co)polymer. In additional exemplary embodiments, the microporous material further includes one or more adjuvants selected from the group consisting of anti-static materials, surfactants, nucleating agents, dyes, plasticizers, UV absorbers, thermal stabilizers, flame retardants, nucleating agents, anti-oxidants, particulate fillers, and anti-oxidants.

In yet another aspect, the disclosure describes a microporous film including any of the foregoing microporous materials. In a further aspect, the disclosure describes a multi-layer microporous membrane including a first layer comprising a first porous film, a second layer disposed on a major side of the first layer, wherein the second layer includes any of the foregoing microporous films, and optionally,(a third layer disposed on a major side of the second layer opposite the first layer, wherein the third layer comprises a second porous film. In some exemplary embodiments, the first and second porous films are comprised of different materials.

In an additional aspect, the disclosure describes an article including any of the foregoing microporous films, wherein the article is selected from a battery separator, a capacitor separator, a fluid filtration article, or a separation article. In some exemplary embodiments, the microporous film exhibits a puncture resistance of at least 300 g/25 micrometers.

Various aspects and advantages of exemplary embodiments of the disclosure have been summarized. The above Summary is not intended to describe each illustrated embodiment or every implementation of the present disclosure. The Drawings and the Detailed Description that follow more particularly exemplify certain suitable embodiments using the principles disclosed herein.

### BRIEF DESCRIPTION OF DRAWINGS

FIG. 1A is a micrograph showing a portion of an exemplary microporous membrane with a fibrillar mesh structure prepared according to the exemplary embodiment of Example 1.

FIG. 1B is a graph of charging capacity as a function of cycle time for an exemplary lithium ion battery incorporating as a battery separator the exemplary microporous membrane having a fibrillar mesh structure prepared according to the exemplary embodiment of Example 1.

FIG. 2 is a micrograph showing a portion of an exemplary microporous membrane with a fibrillar mesh structure prepared according to the exemplary embodiment of Example 2.

FIG. 3 is a micrograph showing a portion of an exemplary microporous membrane with a fibrillar mesh structure prepared according to the exemplary embodiment of Example 3.

FIG. 4 is a micrograph showing a portion of an exemplary microporous membrane with a fibrillar mesh structure prepared according to the exemplary embodiment of Example 4.

FIG. 5A is a micrograph showing a portion of an exemplary microporous membrane with a fibrillar mesh structure prepared according to the exemplary embodiment of Example 5.

FIG. 5B is another micrograph showing a portion of an exemplary microporous membrane with a fibrillar mesh structure prepared according to the exemplary embodiment of Example 5.

FIG. 6A is a micrograph showing an air quenched side portion of an exemplary microporous membrane with a fibrillar mesh structure prepared according to the exemplary embodiment of Example 6.

FIG. 6B is another micrograph showing a wheel quenched side portion of an exemplary microporous membrane with a fibrillar mesh structure prepared according to the exemplary embodiment of Example 6.

FIG. 7 is a micrograph showing an exemplary microporous membrane without a fibrillar mesh structure prepared according to Comparative Example 1.

While the above-identified drawings, which may not be drawn to scale, set forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

As used throughout this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used throughout this specification and the appended embodiments, the words “suitable” and “preferably” refer to embodiments of the disclosure that may afford certain benefits under certain circumstances. Other embodiments may also be suitable, however, under the same or other circumstances. Furthermore, the recitation of one or more suitable embodiments does not imply that other embodiments are not useful, and is not intended to exclude other embodiments from the scope of the disclosure.

As used throughout this specification and the appended embodiments, the term “comprises” and variations thereof do not have a limiting meaning where these terms appear in the description and claims.

As used throughout this specification and the appended embodiments, the recitation of numerical ranges by endpoints includes all numbers subsumed within that range (e.g. 1 to 5 includes 1, 1.5, 2, 2.75, 3, 3.8, 4, and 5).

Unless otherwise indicated throughout this specification and the appended embodiments, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, including the claims:

### GLOSSARY

The term “(co)polymer” is used herein to refer to a homo(co)polymer or a (co)polymer.

The term “normally melt processable” or simply “melt processable” is used herein to refer to (co)polymers that are melt-processable under ordinary melt-processing conditions using conventional extrusion equipment without the need for plasticizer addition.

The term “melting temperature” is used herein to refer to the temperature at or above which the (co)polymer component in a blend with a compound or a compatible liquid will melt.

The term “crystallization temperature” refers to the temperature at or below which the (co)polymer component in a blend with a compound or diluent, will crystallize.

The term “liquid-liquid phase separation temperature” is used to refer to the temperature at or below which a melt of a mixture of a (co)polymer and a compatible liquid, i.e., a homogeneous (co)polymer-melt, phase separates by either binodal or spinodal decomposition.

The term “microporous” is used herein to mean a material comprising a network of interconnected pores having a median diameter less than one micrometer.

The term “stretch ratio” is used herein to mean the ratio of the length of a sheet after being stretched in a specified stretch direction divided by the length of the sheet in the same direction prior to stretching.

The term “removing at least a substantial portion of the second component” is used herein to mean removing more than 50% by weight, and up to 100% by weight, of the second component from the sheet.

The term “compatible” or “a compatible mixture” is used herein to refer to a material capable of forming a fine dispersion (less than 1 micron in particle size) in a continuous matrix of a second material or capable of forming an inter-penetrating (co)polymer network of both materials.

Terms of orientation such as “atop”, “on”, “covering”, “uppermost”, “underlying” and the like for the location of various elements in the disclosed article(s) refer to the relative position of an element with respect to a horizontally-disposed, upwardly-facing substrate. It is not intended that the substrate or articles should have any particular orientation in space during or after manufacture.

The term “separated by” to describe the position of a layer with respect to two or more other layers refers to the layer as being between the two or more other layers, but not necessarily contiguous to any of the other layers.

The term “wt %” is used in accordance with its conventional industry meaning and refers to an amount based upon the total weight of solids in the referenced composition.

The microporous materials of the present disclosure are made using melt-processable (co)polymers in a melt-processable material. The melt-processed materials are made microporous by phase separating from the melt-processed material a compound that is miscible with the thermoplastic (co)polymer component at a temperature above the melting temperature of the thermoplastic (co)polymer component but that phase separates from the (co)polymer component when cooled below the crystallization temperature of the component.

A number of methods for making microporous films and membranes are taught in the art. One of the most useful methods involves thermally induced phase separation. Generally such a process is based on the use of a (co)polymer that is soluble in a diluent at an elevated temperature but that is insoluble in the diluent material at a relatively lower temperature Examples of such methods are described in U.S. Pat. Nos. 4,539,256, 4,726,989, and 5,120,594; and Pub. U.S. Pat. App. 20110244013.

### Microporous Materials

Various exemplary embodiments of the disclosure will now be described, with particular reference to the Examples and the Figures. Exemplary embodiments of the disclosure may take on various modifications and alterations without departing from the spirit and scope of the disclosure. Accordingly, it is to be understood that the embodiments of the disclosure are not to be limited to the following described exemplary embodiments, but is to be controlled by the limitations set forth in the claims and any equivalents thereof.

The present disclosure illustrates, in exemplary embodiments, a microporous film with a unique morphology that is made by stretching of a solid/liquid Thermally Induced Phase Separation (TIPS) film. The microporous film is comprised of a plurality of filaments substantially aligned in a first longitudinal direction, and a mesh extending between the filaments, the mesh comprising a network of interconnected pores (i.e. micropores) having an effective diameter of one micrometer or less. The microporous film is formed by bi-directional (e.g. bi-axial) stretching of a (co)polymeric sheet of film formed by a TIPS process subsequent to removal of a substantial portion of the diluent phase, for example, by washing with a fluid which selectively acts substantially as a solvent for the diluents phase, and substantially as a non-solvent for the (co)polymer phase.

Preferably, the bi-directional stretching occurs in a first direction at low elongation (e.g. stretch ratio between 1:1 and 3:1), and in a second direction at higher elongation (e.g., stretch ratio greater than 3:1, 4:1, 5:1, 6:1, 7:1, 8:1, 9:1, 10:1, 11:1 or even as high as 12:1). Preferably, the first direction is substantially orthogonal to the second direction.

In some exemplary embodiments, a microporous material is prepared including a melt-processable, semi-crystalline, thermoplastic (co)polymer, wherein the thermoplastic (co)polymer is miscible in a compatible liquid when heated above a melting temperature of the semi-crystalline thermoplastic (co)polymer, further wherein the microporous material is comprised of a plurality of filaments substantially aligned in a first longitudinal direction, and a mesh extending laterally between the filaments, the mesh comprising a network of interconnected pores having a median diameter less than one micrometer. In further exemplary embodiments, a microporous material is prepared according to any of the methods described below.

### Melt-Processable, Semi-Crystalline, Thermoplastic (Co)Polymer Component

In exemplary embodiments, the microporous material comprises a melt-processable, semi-crystalline, thermoplastic (co)polymer component comprising a semi-crystalline, thermoplastic (co)polymer selected from the group consisting of polypropylene, high density polyethylene, poly(ethylene chlorotrifluoroethylene), and compatible blends thereof.

Generally, melt-processable, semi-crystalline thermoplastic (co)polymers are those that can be extruded through either a single screw extruder or a twin screw extruder with or without the aid of plasticizing materials. Useful thermoplastic (co)polymers are those that can undergo processing to impart a high orientation ratio in a manner that enhances their mechanical integrity, and are semi-crystalline in nature. Thermoplastic (co)polymers useful in the present disclosure are normally melt-processable semi-crystalline thermoplastic (co)polymers.

Orienting semi-crystalline thermoplastic (co)polymers may significantly improve the strength and elastic modulus in the orientation direction, and orientation of a semi-crystalline thermoplastic (co)polymer below its melting point may result in extended chain crystals with fewer chain folds and defects. The most effective temperature range for orienting semicrystalline (co)polymers is between the alpha crystallization temperature of the (co)polymer and its melting point. The alpha crystallization temperature (or alpha transition temperature) corresponds to a secondary transition of the (co)polymer at which crystal sub-units can be moved within the larger crystal unit. The melting point corresponds to the temperature at which a solid phase changes to a liquid phase.

Particularly suitable (co)polymers therefore are those that exhibit an alpha transition temperature and include, for example: high density polyethylene, linear low density polyethylene, ethylene alpha-olefin (co)polymers, polypropylene, poly(ethylene chlorotrifluoro ethylene), and compatible blends thereof. Blends of one or more “compatible” (co)polymers may also be used in practice of the disclosure. Miscibility and compatibility of (co)polymers are determined by both thermodynamic and kinetic considerations. Common miscibility predictors for non-polar (co)polymers are differences in solubility parameters or Flory-Huggins interaction parameters.

Polyolefin Semi-Crystalline Thermoplastic (Co)Polymers

For (co)polymers with non-specific interactions, such as polyolefins, the Flory-Huggins interaction parameter can be calculated by multiplying the square of the solubility parameter difference by the factor (V/RT), where V is the molar volume of the amorphous phase of the repeated unit V=M_{w}/ρ (molecular weight/density), R is the universal gas constant, and T is the absolute temperature. As a result, Flory-Huggins interaction parameter between two non-polar (co)polymers is always a positive number. Thermodynamic considerations require that for complete miscibility of two (co)polymers in the melt, the Flory-Huggins interaction parameter has to be very small (e.g. less than 0.002 to produce a miscible blend starting from 100,000 weight-average molecular weight components at room temperature).

It is difficult to find (co)polymer blends with sufficiently low interaction parameters to meet the thermodynamic condition of miscibility over the entire range of compositions. However, industrial experiences suggest that some blends with sufficiently low Flory-Huggins interaction parameters, although still not miscible based on thermodynamic considerations, form compatible blends. Unlike miscibility, compatibility is difficult to define in terms of exact thermodynamic parameters, since kinetic factors, such as melt processing conditions, degree of mixing, and diffusion rates can also determine the degree of compatibility.

Some examples of compatible polyolefin blends are: high density polyethylene and ethylene alpha-olefin (co)polymers; polypropylene and ethylene propylene rubber; polypropylene and ethylene alpha-olefin (co)polymers; polypropylene and polybutylene.

In the presence of a common diluent or oil component that is miscible with all (co)polymers in a blend above their melting temperatures, the thermodynamic requirements for miscibility relax. Two (co)polymers with a Flory-Huggins interaction parameter that is significantly greater than the critical value for miscibility in a binary system, can still be miscible in a melt comprising a ternary system with a common solvent, at least over a range of compositions.

Compatibility affects the range of useful (co)polymer concentrations when (co)polymer blends are employed. If the (co)polymers are incompatible, that range of compositions can be quite narrow, restricted to very low (co)polymer concentrations, and of minimal practical usefulness in making the inventive articles. However, if (co)polymers are compatible, a common solvent can promote their miscibility into the composition regions of much higher (co)polymer concentrations, thus allowing the use of common processing techniques such as extrusion to make articles of this disclosure. Under these conditions, all components in the melt are miscible and phase-separate by crystallization. The rate of cooling is quite rapid and controlled by the process conditions that minimize the size of phase-separated polymer microdomains and provides uniformity on a microscopic level.

Compatibility also affects film uniformity. Cast films that are made from compatible blends by the method of this disclosure are transparent which confirms the uniformity on a microscopic level. This uniformity is of great importance for successful post-processing: films with a lesser degree of uniformity made from incompatible (co)polymers break easily during stretching. Film uniformity is also important in some applications, such as thermal shutdown battery separators, for which reliable shutdown performance on a microscopic level is desirable.

ECTFE Semi-Crystalline Thermoplastic (Co)Polymers

In general, suitable ECTFE (co)polymers are partially fluorinated, semi-crystalline (e.g., at least partially crystalline) (co)polymers possessing a combination of mechanical properties. Suitable ECTFE (co)polymers include resins available from commercial sources such as those available from Solvay Solexis, Inc. (West Deptford, N.J.) under the trade designation “HALAR.” Suitable commercial resins include HALAR 300, 901 and 902 ECTFE (co)polymer materials are used in various embodiments of the disclosure.

### Second Component or Compounds (Diluents)

Materials useful as the second component or compound are those that form a solution with the chosen melt-processable thermoplastic (co)polymer or (co)polymer mixture at an elevated temperature to form a solution but that also permit the components to phase separate when cooled. This component may sometimes be referred by shorthand simply as the “blending compound” or the “diluent.” Useful blending compound materials include those mentioned as useful compounds in Shipman, U.S. Pat. No. 4,539,256, incorporated herein by reference, and additional materials such as, dodecyl alcohol, hexadecyl alcohol, octadecyl alcohol, paraffin wax, liquid paraffin, stearyl alcohol, and dibutyl sebacate.

Compounds suitable to make the microporous material of the disclosure by crystallization precipitation may be liquids or solids at room temperature. These compounds generally are also materials in which the crystallizable thermoplastic (co)polymer will dissolve to form a solution at a temperature above the melting temperature of the thermoplastic (co)polymer component but that will phase separate on cooling at or below the crystallization temperature of the thermoplastic (co)polymer component. These compounds preferably have a boiling point at atmospheric pressure at least as high as the melting temperature of the thermoplastic (co)polymer. Compounds having lower boiling points may be used in those instances where superatmospheric pressure may be employed to elevate the boiling point of the compound to a temperature at least as high as the melting temperature of the thermoplastic (co)polymer component.

In certain exemplary embodiments, the second component or compound is selected from the group consisting of mineral oil, mineral spirits, paraffin wax, liquid paraffin, petroleum jelly, dioctylphthalate, dodecyl alcohol, hexadecyl alcohol, octadecyl alcohol, stearyl alcohol, dibutyl sebacate, and mixtures thereof which are miscible with the thermoplastic (co)polymer component at a temperature above the melting temperature of the thermoplastic semi-crystalline (co)polymer.

Second Component Compounds (Diluents) for Polyolefins

Exemplary diluents for polyolefins include, but are not limited to, mineral oil, paraffin oil, petroleum jelly, dibutyl sebecate, wax and mineral spirits for example. Some examples of combinations of (co)polymers and diluents include, but are not limited to, polypropylene with mineral oil, petroleum jelly, wax or mineral spirits; polypropylene-polyethylene (co)polymer with mineral oil; polyethylene with mineral oil, dibutyl sebecate, wax, or mineral spirits; and mixtures and blends thereof.

Particularly useful diluents with polypropylene are mineral oil, dioctylphthalate, or mineral spirits. Mineral oil and mineral spirits are examples of mixtures of blending compounds since they are typically blends of hydrocarbon liquids. These are especially useful in some of the (co)polymer mixture of the present disclosure.

The amount of diluent can depend at least in part on the particular diluent, the particular (co)polymer, the amount of the (co)polymer and nucleating agent if necessary, the desired porosity, pore size, puncture strength, and modulus, or combinations thereof. In an embodiment, the melt blend can include less than 80% diluent based on the total weight of the melt blend to about 30% diluent based on the total weight of the melt blend.

Second Component Compounds (Diluents) for ECTFE (Co)Polymers

Suitable diluents include organic esters such as: sebacic acid esters such as, for example, dibutyl sebacate (DBS); phthalic acid esters such as dioctyl phthalate (DOP), diethyl phthalate (DEP); trimellitic acid esters; adipic acid esters; phosphoric acid ester; azelaic acid ester, and combinations of two or more of the foregoing. The amount of diluent used to prepare a microporous materials of the present disclosure may vary. In embodiments of the disclosure, a mixture of ECTFE (co)polymer and diluent is prepared with a weight ratio of ECTFE (co)polymer/diluent within the range between about 70/30 and about 30/70.

### Optional Additives (Adjuvants)

The microporous materials of the disclosure may also contain, in addition to compounds described above, one or more adjuvants selected from the group consisting of anti-static materials, surfactants, nucleating agents, dyes, plasticizers, UV absorbers, thermal stabilizers, flame retardants, nucleating agents, anti-oxidants, particulate fillers, anti-oxidants, and the like.

Adjuvants, especially particulate fillers, should generally be added in a limited quantity, for example, less than 50 wt %, 40 wt %, 30 wt %, 25 wt %, 20 wt %, 15 wt %, or even 10 wt %, so as not to interfere with the formation of the microporous material, and so as not to result in unwanted exuding of the additive. The amount of adjuvant is typically less than 10% of the weight of the (co)polymeric mixture, preferably less than 5% or even 2.5% by weight of the weight of the (co)polymeric mixture.

Imbibed Fillers

The microporous film can be imbibed with various fillers to provide any of a variety of specific functions, thereby providing unique articles. For example, the imbibing material or filler may be a liquid, solvent solution, solvent dispersion or solid. The filler may be a particulate filler. Fillers may be imbibed by any of a number of known methods which results in the deposition of such fillers within the porous structure of the microporous sheet. Some imbibing materials are merely physically placed within the microporous sheet. In some instances, the use of two or more reactive components as the imbibing materials permits a reaction within the microporous sheet structure. Examples of suitable imbibing material include antistatic agents, surfactants, solid particulate material such as activated carbon and pigments, and thermal and UV stabilizers.

Nucleating Agents

If desired, a nucleating agent may be used. The nucleating agent employed in the present invention may serve the important functions of inducing crystallization of the (co)polymer from the liquid state and enhancing the initiation of polymer crystallization sites so as to hasten the crystallization of the polymer. Because the nucleating agent serves to increase the rate of crystallization of the (co)polymer, the size of the resultant (co)polymer particles or spherulites is reduced.

The use of nucleating agents in the preparation of microporous materials has been described in U.S. Pat. No. 4,726,989 (Mrozinski). Generally nucleating agents, if present, are used in amounts of 0.05 to 5 parts by weight, relative to the sheet composition (i.e. the combination of (co)polymer, diluent and any other adjuvants).

Some examples of useful nucleating agents for polyolefins include aryl alkanoic acid compounds, benzoic acid compounds, and certain dicarboxylic acid compounds and certain pigments. In particular, the following specific nucleating agents have been found useful: dibenzylidine sorbitol, titanium dioxide (TiO₂), talc, adipic acid, benzoic acid, azo red pigment, green and blue phthalocyanine pigments, and fine metal particles.

It will be understood that the foregoing nucleating agents are given by way of example only, and that the foregoing list is not intended to be comprehensive. Other nucleating agents that may be used in connection with thermoplastic polymers are well known, and may also be used to prepare microporous materials in accordance with the present invention. Additionally, fluorochemical additives should be selected that do not adversely affect the heterogeneous nucleation function of the nucleating agent, when such agents are employed.

Nucleating Agents for ECTFE (Co)Polymers

In exemplary embodiments including an ECTFE (co)polymer, the ECTFE (co)polymer/diluent blend preferably includes at least one nucleating agent to induce, accelerate and enhance the crystallization of ECTFE (co)polymer during the TIPS process and to provide a film or membrane product that has a strong microstructure of (co)polymer domains that form as the ECTFE (co)polymer crystallizes from a melt. The microstructure then becomes high modulus and porous after removing the diluent, drying, and imbalanced stretching.

Nucleating agent(s) useful for ECTFE (co)polymer comprises fine particulates suspended in a (co)polymer base and nucleating agents that are uniformly dispersible in an ECTFE (co)polymer/diluent in an amount sufficient to initiate crystallization of the ECTFE (co)polymer at enough nucleation sites to create an initial (co)polymer node and fibril structure before stretching.

In some exemplary embodiments of the disclosure, the amount of nucleating agent that is required is between about 0.01 wt % (100 ppm) and about 2.0 wt % of the ECTFE/diluent mixture. In other embodiments, the amount of nucleating agent is no more than about 1.0 wt %, or between about 0.05 wt % and about 1.0 wt %, or between about 0.25 wt % and about 1.0 wt % of the ECTFE/diluent mixture.

In some exemplary embodiments of the disclosure, effective nucleating agents for crystallizing ECTFE (co)polymer from a TIPS diluent solution comprise any of a variety of fluoro(co)polymers selected from: (co)polymers of tetrafluoroethylene and ethylene (ETFE); (co)polymers of tetrafluoroethylene, hexafluoropropylene and vinylidene fluoride (THV); (co)polymers of tetrafluoroethylene and hexafluoropropylene (FEP); and combinations of two or more of the foregoing. Commercially available fluoro(co)polymers that are suitable for use as nucleating agents include ETFE (co)polymer available under the trade designation “ETFE 6235Z” from Dyneon LLC of Oakdale, Minn.; THV (co)polymer available under the trade designation “THV 815Z” from Dyneon LLC; FEP (co)polymer available under the designation “FEP 6322Z” from Dyneon LLC; and ETFE (co)polymers available under the designation “Tefzel” (e.g., Tefzel 200, Tefzel 750, and Tefzel 2188) from DuPont of Wilmington, Del.

There are characteristics of a fluoro(co)polymer to be considered as a nucleating agent for use in the ECTFE TIPS process described herein. A material intended for use as a nucleating agent must be substantially uniformly dispersible in the ECTFE (co)polymer to form an essentially homogenous melt mixed composition. Additionally, the crystallization temperature of the nucleating agent should be higher than the crystallization temperature of the ECTFE (co)polymer so that the nucleating agents will crystallize first during cooling of a melt mixed composition following extrusion. In this manner, micro particles of fluoro(co)polymers will form and be available to act as true nucleating agents when the ECTFE (co)polymer reaches its own crystallization temperature.

### Method of Making Microporous Materials

In exemplary embodiments, the present disclosure describes a method of making a microporous material, comprising:
(a) melt blending to form a substantially homogeneous melt-blended mixture comprising from about 20 to about 70 parts by weight of a melt-processable, semi-crystalline, thermoplastic (co)polymer component, and from about 30 to about 80 parts by weight of a second component comprising a compound that is miscible with the thermoplastic (co)polymer component at a temperature above a melting temperature of the thermoplastic semi-crystalline (co)polymer but that phase separates from the thermoplastic (co)polymer component when cooled below a crystallization temperature of the thermoplastic semi-crystalline (co)polymer;
(b) forming a sheet of the melt blended mixture;
(c) cooling the sheet to a temperature at which phase separation occurs between the second component and the thermoplastic (co)polymer component through crystallization precipitation of the thermoplastic (co)polymer component;
(d) removing at least a substantial portion of the second component to provide a porous sheet; and
(e) stretching the porous sheet in a direction at a stretch ratio between 1:1 and 3:1, and stretching the sheet in a substantially orthogonal direction at a stretch ratio of more than 4:1, thereby forming a microporous material comprising a network of interconnected pores having a median diameter less than one micrometer.

Optionally, the microporous material exhibits a puncture resistance of at least 300 g/25 micrometers, at least 350 g/25, at least 375 micrometers, at least 400 g/25 micrometers, at least 425 g/25 micrometers, or even as much as 450 g/25 micrometers.

In exemplary methods, a melt solution may be prepared by mixing the thermoplastic (co)polymer component and the blending compound under agitation such as that provided by an extruder and heating until the temperature of the mixture is above the melting point of the (co)polymer component. At this point the mixture becomes a melt solution or single phase.

The melt solution may also be prepared by mixing the (co)polymer and blending compound or compatible liquid in a continuous mixing device such as an extruder. Preferably, the blending compound is added after the (co)polymer component is melted. Once the melt solution is mixed sufficiently to make a homogeneous melt, it is shaped in a form of a film or a sheet by a flat sheet or film die or by an annular die (as in a blown film line).

Cooling of the sheet may occur, for example, by contacting the shaped material with a casting wheel, a water bath, or with air. Cooling causes the phase separation to occur between the blending component and the thermoplastic (co)polymer component. While not wishing to be bound by any particular theory, it is presently believed that phase separation occurs by crystallization precipitation of the (co)polymer component to form a network of (co)polymer domains. It will be understood that crystallization must be sufficient to achieve the overall desired number of crystal sites. The crystallization rate is impacted by known processing conditions, and in those cases where the rate of crystallization is excessively slow additional factors must be considered, such as increased heat transfer (i.e., faster quench rate) and/or the addition of nucleating agents.

Removal of the second component (compound or diluents) is achieved through a removal step before the stretching or orientation step to obtain a porous sheet. The removal may be carried out by washing, solvent extraction, or by using other known methods, for example, those described in U.S. Pat. No. 5,993,954.

Specified stretching or orientation is used to achieve a new fibrillar-mesh structure or morphology, as compared to known microporous films. The material, in sheet, web or film form, is stretched biaxially, i.e. in at least two orthogonal (i.e. perpendicular) directions. The porous sheet is stretched in a direction at a stretch ratio between 1:1 and 3:1, and stretched in a substantially orthogonal direction at a stretch ratio of more than 4:1, thereby forming a microporous material comprising a network of interconnected pores having a median diameter less than one micrometer.

In some exemplary embodiments, the porous sheet, after biaxial stretching (step (e)), exhibits a major surface areal expansion ratio of more than 4:1, at least 5:1, 6:1, 7:1, 8:1, 9:1, 10:1, 11:1 or even as much as 12:1 or even 15:1. In certain exemplary embodiments, the porous sheet is stretched in the substantially orthogonal direction before the porous sheet is stretched in the direction at the stretch ratio between 1:1 and 3:1. (In other exemplary embodiments, the porous sheet is stretched in the substantially orthogonal direction after the porous sheet is stretched in the direction at the stretch ratio between 1:1 and 3:1. In alternative exemplary embodiments, the porous sheet is stretched in each direction at substantially the same time.

In further exemplary embodiments, the porous sheet is stretched in the substantially orthogonal direction at a stretch ratio of no more than 12:1, no more than 11:1, 10:1, 9:1, 8:1, 7:1, 6:1 or even 5:1.

As noted above, the biaxial stretching may be performed either sequentially or simultaneously. Sequential stretching may be carried out by drawing the porous sheet with a length orienter and a tenter (i.e., orienting down-web and cross-web respectively). Simultaneous stretching may be carried out by drawing the film in both directions at the same time. However, in each instance, the degree of stretch is different in each direction.

To achieve adequate orientation of the semi-crystalline thermoplastic (co)polymer component, the film is preferably stretched at a temperature above the alpha crystallization temperature and generally should be stretched enough to orient the mobile crystal structures into a fibrillar morphology. The most effective temperature range for orienting semicrystalline (co)polymers is between the alpha crystallization temperature of the (co)polymer and its melting point. While not wishing to be bound by any particular theory, it is presently believed that above the alpha crystallization temperature lamellar slip in larger crystal units, such as spherulites, occurs and extended chain crystals form. It is difficult to effectively orient (co)polymers that do not have the alpha transition to any great extent because their crystal segments cannot be easily rearranged into an aligned state. direction.

Generally the pore size and percent void volume of the washed and stretched microporous material are determined by the amount of blending compound or compatible liquid used to make it, quench conditions, and the amount of stretch imparted to the film after washing to remove the diluent. Preferably from 20 to 70 parts of a polymer compound or from 30 to 80 parts of a compatible liquid are used per 100 parts of total composition. As less blending compound or compatible liquid is used, the porosity and pore interconnectivity generally decrease. As more blending compound or compatible liquid is used, the porosity and pore interconnectivity generally increase, but mechanical properties (e.g., tensile properties and puncture resistance) generally decrease.

Porosity, pore interconnectivity, and mechanical properties are, however, also influenced by (co)polymer types, component concentration, processing conditions (e.g., quenching rate and/or stretching temperature) and by the presence or absence of a nucleating agent. Thus, judicious selection of (co)polymer materials and concentrations, blending compound or compatible liquid concentrations, and processing conditions will result in desired porosity, pore interconnectivity, and mechanical properties.

### Articles Incorporating Microporous Materials

In further exemplary embodiments, the disclosure provides a microporous film including any of the foregoing microporous materials. In some exemplary embodiments, the disclosure provides a multi-layer microporous membrane including a first layer comprising a first porous film, a second layer disposed on a major side of the first layer, wherein the second layer includes any of the foregoing microporous films, and optionally a third layer disposed on a major side of the second layer opposite the first layer, wherein the third layer comprises a second porous film. In some exemplary embodiments, the first and second porous films are comprised of different materials.

In additional exemplary embodiments, the disclosure provides an article including any of the foregoing microporous films, wherein the article is selected from a battery separator, a capacitor separator, a fluid filtration article, or a separation article. In some exemplary embodiments, the microporous film exhibits a puncture resistance of at least 300 g/25 micrometers.

Thus, the microporous materials (and articles containing at least one microporous material as disclosed herein) may be used in a variety of applications including, but not limited to, transdermal drug delivery, separators for lithium ion batteries and capacitors, filters for purification, sterilization, or both of fluid streams in the biopharma, food and beverage, or electronics industries for example; substrates for holding gel formulations and functional coatings; and substrates to separate but still allow for liquid/liquid extraction inside the membrane.

Further, microporous materials as disclosed herein can be useful in the formation of smaller pore size membranes wherein particles and/or coatings are introduced into the porous structure of porous membranes to impart functionality to the outer and/or interstitial surfaces of porous membranes as disclosed herein. For example, topical coatings, outer and/or interstitial surface treatments or gels may be incorporated into porous membranes to impart functionality (e.g., hydrophilicity, selective low binding characteristics, or selective high binding characteristics) to porous membranes.

By starting with membranes that have a larger pore size, porous membranes can enable processing flexibility for producing a variety of specialized, functionalized porous membranes having an appropriate coating/interstitial filling material and still be capable of an acceptable fluid flow rate through the porous membrane. Exemplary techniques and materials for providing functionalized surfaces to porous membranes as disclosed herein are described in U.S. Pat. No. 7,553,417.

Another aspect of the disclosure relates to creating a multi layer film material comprised of at least one layer of the newly formed membrane morphology with at least one other layer of a similar new morphology but having a different pore size, or with a layer(s) of membrane with conventional morphology and/or with a layer(s) of nonwoven with a fibrous morphology.

A multi-layer microporous material or film of the present disclosure may be made employing the above-described microporous materials as a layer with at least one additional porous layer. By way of example, in a three-layer system the above-described porous layer is preferably the center layer sandwiched by, i.e., in between the additional porous layers.

The additional porous layers may include the same porous layer above described, namely, the phase-separated (co)polymeric film or may also include a crystallization phase-separated, melt-processable (co)polymer such as described in U.S. Pat. No. 4,539,256, or a porous layer comprising a liquid-liquid phase-separated, melt-processable (co)polymer as described in U.S. Pat. No. 4,867,881.

The additional porous layers may be prepared by melt-blending solutions such as described in U.S. Pat. Nos. 4,539,256 and 4,867,881, the former describing a melt blend solution of a compound with a crystallization phase-separated, melt-processable (co)polymer and the latter describing a melt blend solution of a liquid-liquid phase-separable, melt-processable (co)polymer and a compatible liquid.

The multi-layer film may be formed by coextrusion of the two or more (co)polymer compositions followed by cooling to cause phase separation, washing to remove the diluent, and then orientation of the multi-layer film to form a porous film structure as previously described. The coextrusion may employ a feedblock or a multi-manifold die. The multi-layer film may alternatively be made by laminating one or more of the layers together.

The microporous materials or multi-layer films of the present disclosure may be employed in any of a wide variety of situations wherein microporous structures may be used. They find particular utility as drug delivery membranes and as battery separators.

Thus, in yet another aspect, the microporous materials of the present disclosure may be used to produce a membrane, alone or combined with other conventional materials or films, as a separator in a lithium ion battery (LiIon battery) or electric vehicle (EV) battery or hybrid EV (HEV) battery, or as a separator for a super capacitor. Battery configurations include button or coin cells, stacked, spiral wound cylindrical and spiral wound prismatic cells. Suitable LiIon battery constructions and materials are disclosed in U.S. Pat. Nos. 6,680,145; 6,964,828; 7,078,128; 7,368,071; 7,767,349; and 7,811,710.

Useful attributes of a high performing spiral wound cylindrical cell battery separator membrane include freedom from defects (e.g. no gels or holes), uniform thickness (e.g. caliper <25 μm), readily wet with the electrolyte, porosity >30%, pore size from about 0.05 to about 0.50 μm, uniform morphology top to bottom, good tortuosity, low shrinkage (<5% in the machine direction and cross-web direction at 90° C.), high modulus (>90,000 psi in the machine direction in order to unwind & convert), puncture resistance >300 g/mil thickness, and shutdown temperature of <135° C.

A further aspect of the present disclosure is the use of the microporous material disclosed herein in a small pore size viral filtration membrane, or a composite substrate which incorporates a coated thin film (˜2-5 um thick) useful for ultrafiltration and/or gas separation applications, and the like.

Exemplary embodiments of the present disclosure have been described above and are further illustrated below by way of the following Examples, which are not to be construed in any way as imposing limitations upon the scope of the present disclosure. On the contrary, it is to be clearly understood that resort may be had to various other embodiments, modifications, and equivalents thereof which, after reading the description herein, may suggest themselves to those skilled in the art without departing from the spirit of the present disclosure and/or the scope of the appended claims.

### EXAMPLES

The following examples are intended to illustrate exemplary embodiments within the scope of this disclosure. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Materials

The following terminology, abbreviations, and trade names of materials are used in the Examples:

Melt-Processable, Semi-Crystalline, Thermoplastic (Co)Polymers

Polypropylene (PP) available under the name of F008F from Sunoco Chemicals (Philadelphia, Pa.).

High Density Polyethylene (HDPE) available under the name of FINATHENE 1285 from Total Petrochemicals (Pasadena Tex.).

Poly(ethylene chlorotrifluoroethylene) (ECTFE) available under the names of 901 DA and 902 from Solvay Solexis (Brussels Belgium).

Second Compounds (Diluents)

Mineral oil diluent available under the name SUPERLA WHITE 31 from Amoco Lubricants (now Chevron Lubricants, Richmond, Calif.).

Dibutyl sebecate diluent available from Parchem (New Rochelle, N.Y.).

Nucleating Agents

Polypropylene nucleating agent available under the name NX10 from Milliken Chemical Co. (Spartanburg, S.C.).

Ethylene tetrafluoroethylene (ETFE) nucleating agent available under the designation 6235 from 3M Dyneon (St. Paul, Minn.).

### Test Methods

The following test methods have been used to evaluate microporous materials prepared according to the present disclosure.

Gurley Resistance to Air Flow

Gurley resistance to air flow is the time in seconds for 50 cubic centimeters (cc) of air, or another specified volume, to pass through 6.35 cm² (one square inch) of the porous membrane at a pressure of 124 mm of water according to ASTM D726-58, Method A.

Porosity

The porosity of porous membranes was a calculated porosity value, P_{cal}, based on (i) the measured bulk density of the washed and stretched film (d_{sf}) and (ii) the measured bulk density of the pure (co)polymer (dₚₚ) using the following equation:

P_{cal}=[1−(d_{sf}/(dₚₚ)]×100%.

Thickness

The thickness of a material was measured to the thousandths of an inch using a TMI caliper gauge (Testing Machines Inc., Amityville N.Y.). The measurement was converted into microns.

Bubble Point

The Bubble Point pore size is the bubble point value representing the largest effective pore size in a sample, measured in microns, according to ASTM-F-316-80.

Tensile Strength and Modulus

The tensile and modulus values were measured according to ASTM D 882-97 using an Instron model 1122.

Puncture Resistance

Puncture resistance is a measurement of the chief load required to puncture a perimeter restrained film. The needle is 1.65 mm in diameter with 0.5 mm radius. The rate of descent is 2 mm/sec and the amount of deflection is 6 mm. The film is held tight in the camping device with a central hole of 11.3 mm. The displacement (in mm) of the film that was pierced by the needle was recorded against the resistance force (in gram force) developed by the tested film. The maximum resistance force is the puncture strength. Values are reported as grams per unit thickness.

### Example 1

A microporous material with a new morphology was prepared as follows:

Melt-processable, semi-crystalline (co)polymer (PP) pellets, and masterbatch pellets of polypropylene nucleating agent (NX10) were introduced into the hopper of a 40 mm co-rotating twin screw extruder with a screw speed of 225 RPM. SUPERLA WHITE 31 diluent was injected into the extruder and melt mixed with the PP and nucleating agent to form a homogeneous solution. The weight ratio of the (co)polymer/diluent/nucleating agent was 59.825/40.0/0.175 wt %. The total extrusion rate was about 13.6 kilograms per hour (kg/hr). The extruder had eight zones with the temperature profile set at 260° C. in the mixing zones decreasing in temperature to 204° C. at the extruder outlet/sheeting die. The die had an orifice of 25.4 cm×0.05 cm.

The melt solution was cast on a smooth casting wheel maintained at 60° C. at 6.1 meters/minutes (m/min). The cast film was fed into a solvent washing process where the mineral oil was removed with 3M Novec 71DE solvent. The film was then dried at 100° C. to evaporate the solvent. After drying, the film was stretched in a continuous fashion in the machine direction, MD, at 4.2:1 at 110° C. and traverse direction, TD, at 1.95:1 at 160° C.

Pore properties and modulus values of the resulting microporous material are listed in Table 1.

TABLE 1

| | Example | | | | | |
|---|---|---|---|---|---|---|
| | 1 | 2 | 3 | 4 | 5 | Comparative 1 |
| (Co)polymer Type | PP | PP | HDPE | HDPE | ECTFE | PP |
| Bubble Point (psi) | 97 | 105 | 80 | 88 | 27 | 88 |
| Bubble Point (μm) | 0.093 | 0.085 | 0.110 | 0.102 | 0.33 | 0.102 |
| Thickness (μm) | 20 | 20 | 23 | 25 | 40 | 28 |
| Porosity (%) | 55 | 60 | 60 | 49 | 57 | 65 |
| Modulus MD (psi) | 97,000 | 125,000 | 104,000 | 105,600 | 45,000 | 45,000 |
| Gurley Resistance | 73 | 60 | 55 | 90 | 106 | 94 |
| (sec/50 cc) | | | | | | |
| Puncture Resistance | 320 | 350 | 280 | 450 | 140 | 150 |
| (g/25 μm) | | | | | | |

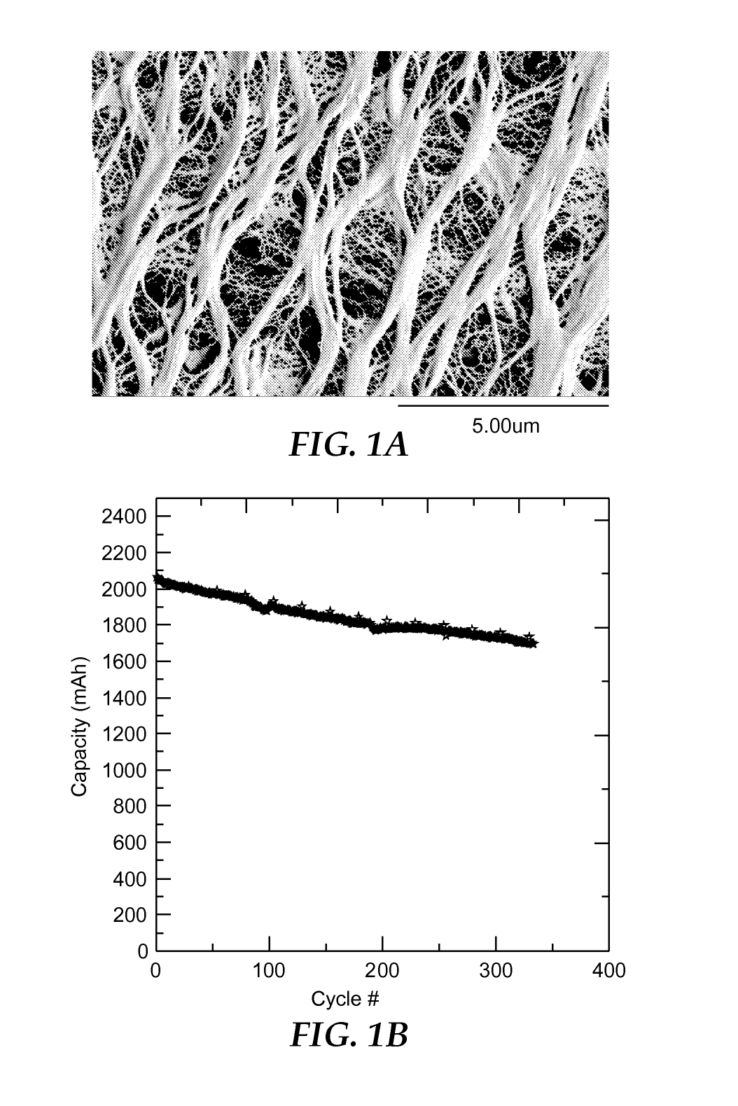

FIG. 1A is a micrograph showing a portion of an exemplary microporous material (i.e. a membrane or film) with a fibrillar mesh structure prepared according to the exemplary embodiment of Example 1.

The microporous material (membrane) with the new morphology of Example 1 was integrated into an 18650 spiral wound cylindrical lithium ion cell for 300 cycles. FIG. 1B is a graph of charging capacity as a function of cycle time for an exemplary lithium ion battery incorporating as a battery separator the exemplary microporous membrane having a fibrillar mesh structure prepared according to the exemplary embodiment of Example 1.

### Example 2

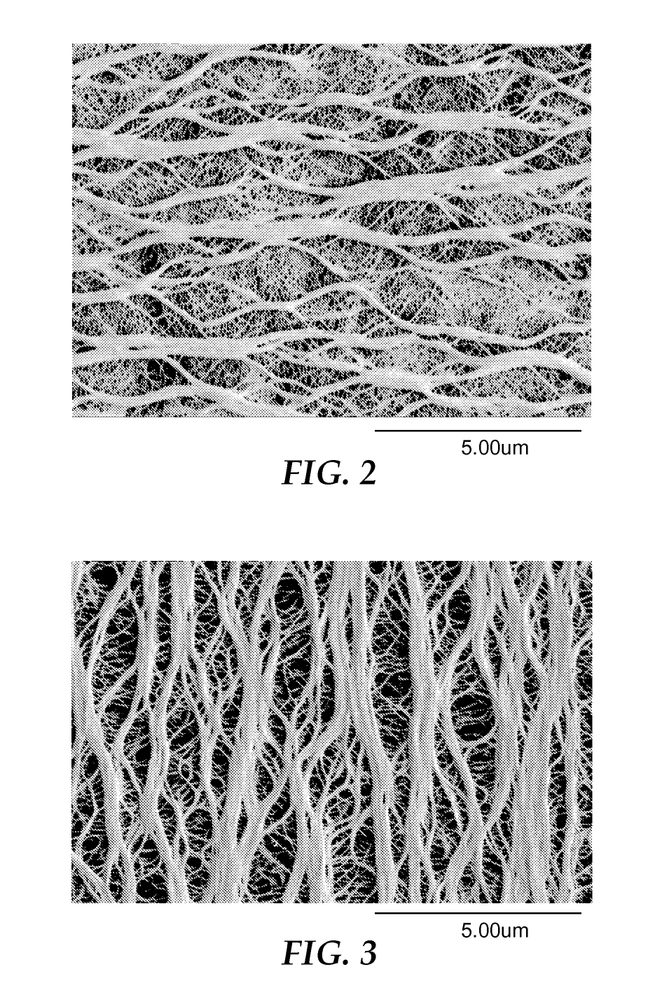

A microporous material with a new morphology was prepared as in Example 1, except the MD stretch ratio was 5.0:1 and the TD stretch ratio was 2.6:1. Pore properties and modulus values of the microporous material are listed in Table 1. FIG. 2 is a micrograph showing a portion of an exemplary microporous material (i.e. a membrane or film) with a fibrillar mesh structure prepared according to the exemplary embodiment of Example 2.

### Example 3

A microporous material with a new morphology was prepared as follows:

Melt-processable, semi-crystalline (co)polymer (HDPE) pellets were introduced into the hopper of a 40 mm co-rotating twin screw extruder with a screw speed of 250 RPM. SUPERLA WHITE 31 diluent was injected into the extruder and melt mixed with the HDPE to form a homogeneous solution. The weight ratio of the (co)polymer/diluent was 45/55 wt %. The total extrusion rate was 15.9 kilograms per hour (kg/hr). The extruder had eight zones with the temperature profile set at 260° C. in the mixing zones decreasing in temperature to 210° C. at the extruder outlet/sheeting die. The die had an orifice of 25.4 cm×0.05 cm.

The melt solution was cast on a smooth casting wheel maintained at 29.4° C. at 4.3 meters/minutes (m/min). The cast film was fed into a solvent washing process where the mineral oil was removed with 3M Novec 71DE solvent. The film was then dried at 77° C. to evaporate the solvent. After drying, the film was MD stretched 5.8:1 at 65.5° C. and TD stretched 1.62:1 at 116° C.

Pore properties and modulus values of the microporous material are listed in Table 1. FIG. 3 is a micrograph showing a portion of an exemplary microporous membrane with a fibrillar mesh structure prepared according to the exemplary embodiment of Example 3.

### Example 4

The same HDPE semi-crystalline thermoplastic (co)polymer pellets and SUPERLA 31 mineral oil diluent used in Example 3 were introduced into the 40 mm co-rotating twin screw extruder with a screw speed of 275 RPM. The weight ratio of the (co)polymer/diluent was 47/53 wt %. The total extrusion rate was 19.0 kilograms per hour (kg/hr). The extruder had eight zones with the temperature profile set at 265° C. in the mixing zones decreasing in temperature to 210° C. at the extruder outlet/sheeting die. The melt solution was cast on a smooth casting wheel maintained at 26.7° C. at 5.2 meters/minutes (m/min).

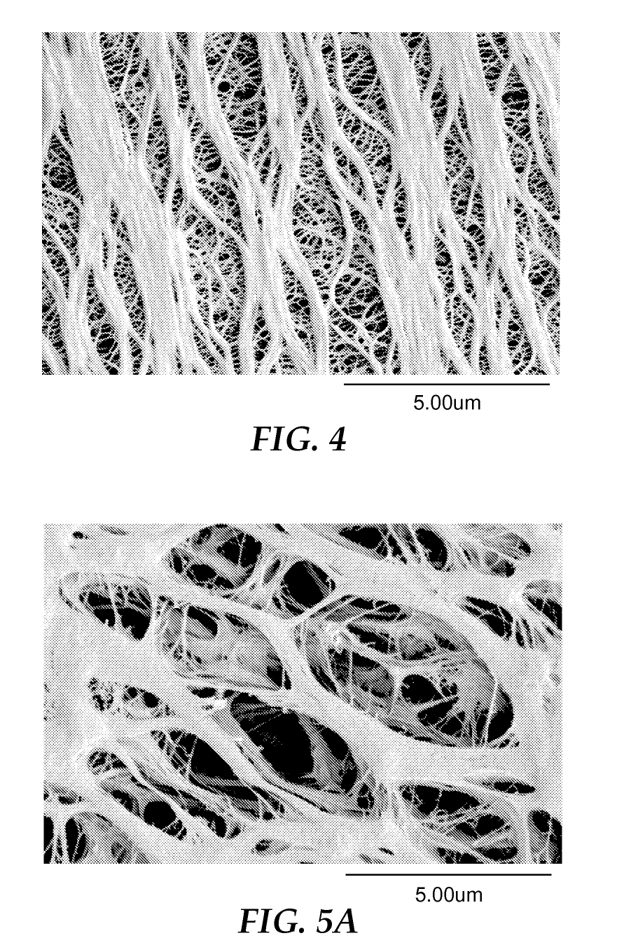

The cast film was washed and dried the same as Example 3. After drying, the film was MD stretched 5.8:1 at 65.5° C. and TD stretched 1.54:1 at 116° C. Pore properties and modulus values are listed in Table 1. FIG. 4 is a micrograph showing a portion of an exemplary microporous membrane with a fibrillar mesh structure prepared according to the exemplary embodiment of Example 4.

### Example 5

A microporous material with a new morphology was prepared as follows:

Melt-processable, semi-crystalline (co)polymers (ECTFE) pellets and an ethylene tetrafluoroethylene, ETFE, (co)polymer used as a nucleating agent for ECTFE (6235 from 3M Dyneon), were introduced into the hopper of a 40 mm co-rotating twin screw extruder with a screw speed of 225 RPM. Dibutyl sebecate was injected into the extruder and melt mixed with the ECTFE base (co)polymer and ETFE nucleating agent (co)polymer to form a homogeneous solution. The weight ratio of the ECTFE (co)polymer/dibutyl sebecate diluent/ETFE nucleating agent (co)polymer was 66.50/33.0/0.50 respectively. The total extrusion rate was about 15.9 kilograms per hour (kg/hr). The extruder had eight zones with the temperature profile set at 260° C. in the mixing zones decreasing in temperature to 224° C. at the extruder outlet/sheeting die. The die had an orifice of 25.4 cm×0.05 cm.

The melt solution was cast on a patterned casting wheel maintained at 49° C. at 6.1 meters/minutes (m/min). The cast film was fed into a solvent washing process where the mineral oil was removed with 3M Novec 71DE solvent. The film was then dried at 77° C. to evaporate the solvent. After drying, the film was stretched in the machine direction, MD, at 4.0:1 at 160° C. and traverse direction, TD, at 1.75:1 at 160° C.

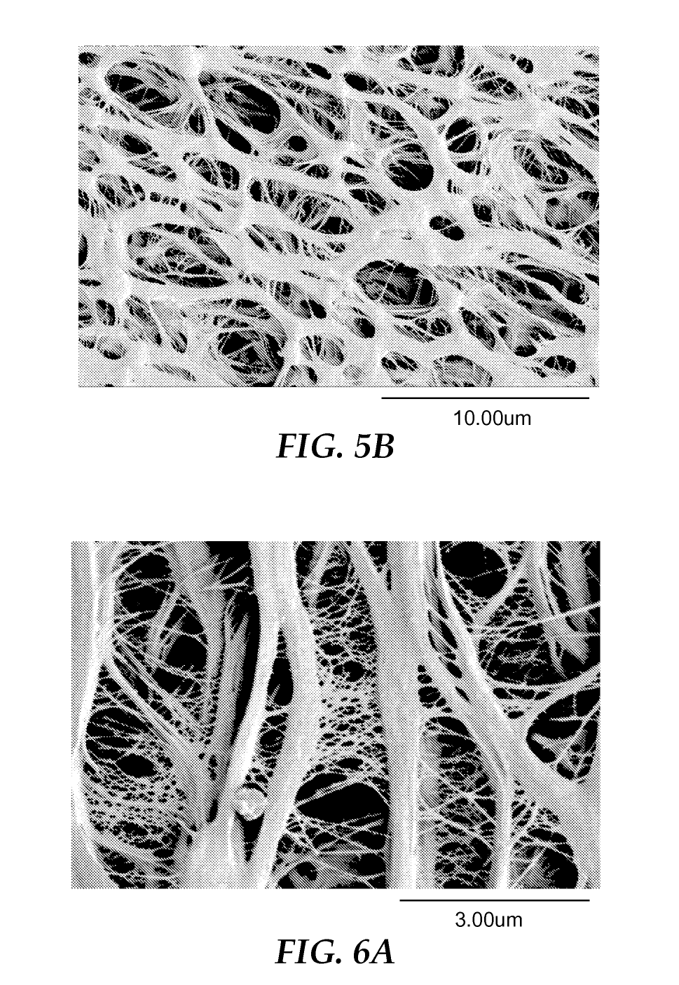

Pore properties are listed in Table 1. FIG. 5A is a micrograph showing a portion of an exemplary microporous membrane with a fibrillar mesh structure prepared according to the exemplary embodiment of Example 5. FIG. 5B is another micrograph showing a portion of an exemplary microporous membrane with a fibrillar mesh structure prepared according to the exemplary embodiment of Example 5.

### Example 6

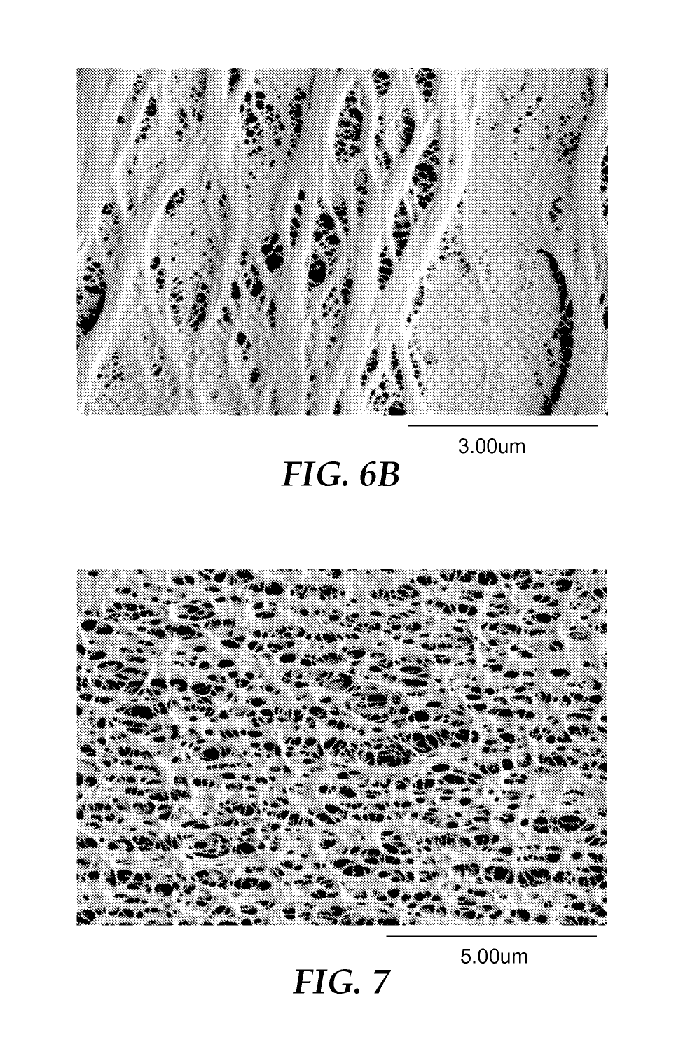

A microporous material with a new morphology was prepared according to Example 5, except that ECTFE 902 polymer was used in the formulation; the weight ratio of the ECTFE (co)polymer/dibutyl sebecate diluent/ETFE nucleating agent (co)polymer was 58.0/41.0/1.0, respectively; the melt solution was cast onto a smooth wheel maintained at 60° C.; the film was stretched in the machine direction, MD, at 5.0:1 at 138° C.; and the traverse direction, TD, at 2.0:1 at 160° C. The exemplary membrane was 18 um thick with 50% porosity. FIG. 6A is a micrograph showing a portion of the air quenched side, and FIG. 6B is a micrograph showing a portion of the wheel quenched side, of the exemplary microporous ECTFE membrane with a fibrillar mesh structure prepared according to Example 6. The air quenched side of the membrane shown in FIG. 6A exhibits a more open structure when compared to the wheel quenched side of the membrane shown in FIG. 6B, which exhibits a tighter asymmetric structure.

### Comparative Example 1

A porous membrane was prepared identically to Example 1 except the weight ratio of the PP/diluent/nucleating agent was 39.8/60.0/0.20, and the film die was maintained at 177° C., and the MD stretch ratio was 1.5:1@99° C. and the TD stretch ratio was 2.6:1@132° C. Table 1 lists the pore properties and modulus values. The modulus value was low and the process conditions did not result in the new morphology. FIG. 7 is a micrograph showing an exemplary microporous membrane without a fibrillar mesh structure prepared according to Comparative Example 1.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, all publications, published patent applications and issued patents referenced herein are incorporated by reference in their entirety to the same extent as if each individual publication or patent was specifically and individually indicated to be incorporated by reference. Various exemplary embodiments have been described. These and other embodiments are within the scope of the following listing of disclosed embodiments.

1. A method of making a microporous material, comprising:
(a) melt blending to form a substantially homogeneous melt-blended mixture comprising:
(i) from about 20 to about 70 parts by weight of a melt-processable, semi-crystalline, thermoplastic (co)polymer component, and
(ii) from about 30 to about 80 parts by weight of a second component comprising a compound that is miscible with the thermoplastic (co)polymer component at a temperature above a melting temperature of the thermoplastic semi-crystalline (co)polymer but that phase separates from the thermoplastic (co)polymer component when cooled below a crystallization temperature of the thermoplastic semi-crystalline (co)polymer;
(b) forming a sheet of the melt blended mixture;
(c) cooling the sheet to a temperature at which phase separation occurs between the second component and the thermoplastic (co)polymer component through crystallization precipitation of the thermoplastic (co)polymer component;
(d) removing at least a substantial portion of the second component to provide a porous sheet; and
(e) stretching the porous sheet in a direction at a stretch ratio between 1:1 and 3:1, and stretching the sheet in a substantially orthogonal direction at a stretch ratio of more than 4:1, thereby forming a microporous material comprising a network of interconnected pores having a median diameter less than one micrometer, wherein the microporous material is comprised of a plurality of filaments substantially aligned in a first longitudinal direction, and a mesh extending laterally between the filaments,
optionally wherein the microporous material exhibits a puncture resistance of at least 300 g/25 micrometers.

2. The method of claim 1, wherein the porous sheet, after step (e), exhibits a major surface areal expansion ratio of more than 4:1.

3. The method of claim 1, wherein the porous sheet is stretched in the substantially orthogonal direction before the porous sheet is stretched in the direction at the stretch ratio between 1:1 and 3:1.

4. The method of claim 1, wherein the porous sheet is stretched in the substantially orthogonal direction after the porous sheet is stretched in the direction at the stretch ratio between 1:1 and 3:1.

5. The method of claim 1, wherein the porous sheet is stretched in each direction at substantially the same time.

6. The method of claim 1, wherein the porous sheet is stretched in the substantially orthogonal direction at a stretch ratio of no more than 12:1.

7. The method of claim 1, wherein the thermoplastic (co)polymer component comprises a semi-crystalline, thermoplastic (co)polymer selected from the group consisting of polypropylene, high density polyethylene, poly(ethylene chlorotrifluoroethylene), and compatible blends thereof.

8. The method of claim 1, wherein the second component is selected from the group consisting of mineral oil, mineral spirits, paraffin wax, liquid paraffin, petroleum jelly, dioctylphthalate, dodecyl alcohol, hexadecyl alcohol, octadecyl alcohol, stearyl alcohol, dibutyl sebacate, and mixtures thereof which are miscible with the thermoplastic (co)polymer component at a temperature above the melting temperature of the thermoplastic semi-crystalline (co)polymer.

9. The method of claim 1, wherein the second component further comprises one or more adjuvants selected from the group consisting of anti-static materials, surfactants, nucleating agents, dyes, plasticizers, UV absorbers, nucleating agents, anti-oxidants, particulate fillers, anti-oxidants, or a combination thereof.

10. The method of claim 1, wherein the sheet is stretched at a temperature between the alpha crystallization temperature and the melting temperature of the semi-crystalline, thermoplastic (co)polymer.

11. A microporous material prepared according to claim 1.

12. A microporous material comprising a melt-processable, semi-crystalline, thermoplastic (co)polymer, wherein the thermoplastic (co)polymer is miscible in a compatible liquid when heated above a melting temperature of the semi-crystalline thermoplastic (co)polymer, further wherein the microporous material is comprised of a plurality of filaments substantially aligned in a first longitudinal direction, and a mesh extending laterally between the filaments, the mesh comprising a network of interconnected pores having a median diameter less than one micrometer.

13. The microporous material of claim 12, wherein the melt-processable, semi-crystalline thermoplastic (co)polymer is selected from the group consisting of polypropylene, high density polyethylene, poly(ethylene chlorotrifluoroethylene), and compatible blends thereof.

14. The microporous material of claim 12, wherein the compatible liquid is selected from the group of consisting of mineral oil, mineral spirits, paraffin wax, liquid paraffin, petroleum jelly, dioctylphthalate, dodecyl alcohol, hexadecyl alcohol, octadecyl alcohol, stearyl alcohol, dibutyl sebacate, and mixtures thereof which are miscible with the thermoplastic (co)polymer at a temperature above the melting temperature of the thermoplastic semi-crystalline (co)polymer.

15. The microporous material of claim 12, further comprising one or more adjuvants selected from the group consisting of anti-static materials, surfactants, nucleating agents, dyes, plasticizers, UV absorbers, nucleating agents, anti-oxidants, particulate fillers, anti-oxidants.

16. A microporous film comprising the microporous material of claim 10.

17. A multi-layer microporous membrane comprising a first layer comprising a first porous film, a second layer disposed on a major side of the first layer, wherein the second layer comprises the microporous film of claim 16, and optionally a third layer disposed on a major side of the second layer opposite the first layer, wherein the third layer comprises a second porous film.

18. The multi-layer microporous membrane of claim 17, wherein the first and second porous films are comprised of different materials.

19. An article comprising the microporous film of claim 16, wherein the article is selected from a battery separator, a capacitor separator, a fluid filtration article, or a separation article.

20. An article according to claim 19, wherein the microporous film exhibits a puncture resistance of at least 300 g/25 micrometers.
